(19) United States
(12) Patent Application Publication
(10) Pub. No.: US 2006/0280315 A1
(43) Pub. Date: Dec. 14, 2006

(54) System and method for delivering audio-visual content along a customer waiting line

(75) Inventors: Elwood G Norris, Poway, CA (US); James J. Croft III, Porway, CA (US)

Correspondence Address: THORPE NORTH & WESTERN, LLP., 8180 SOUTH 700 EAST, SUITE 200, SANDY, UT, 84070, US

(73) Assignee: AMERICAN TECHNOLOGY CORPORATION, San Diego, CA (US)

(21) Appl. No.: 10/560,273

(22) PCT Filed: Jun. 9, 2004
(86) PCT No.: PCT/US04/18639

§ 371 Date: Jul. 13, 2006

Related U.S. Application Data
(60) Provisional application No. 60/477,390, filed on Jun. 9, 2003.

(51) Int. Cl. H04B 3/00

(52) U.S. Cl. 381/77

(57) ABSTRACT

A system for providing audio information to persons in an approach path (12) includes an interaction point (14), and an approach path (12) leading to the interaction point. A parametric sound system (18) is provided, which includes a parametric speaker (20) disposed adjacent to the interaction point. The parametric sound system is configured for limited delivery of sound in a spatially limited audio zone (24) along the approach path (12), within a decibel level above ambient noise levels in the area of the interaction point (14), and sufficiently high to be heard primarily by a person progressing along the approach path (12). The interaction point can be a cashier station, and the system can also include a video display (16) configured to provide video information to persons in the approach path along with the audio information.

### BACKGROUND OF THE INVENTION

1. Field of the Invention

The present invention relates generally to audio and audio-visual systems in public places. More particularly, the present invention relates to a system and method for delivering audio-visual content to persons in a localized approach path, such as a customer waiting line.

2. Related Art

Providing audio-visual content in public spaces can be desirable for many reasons. For example, advertisers frequently compete for the attention of people in crowded public places, such as grocery and department stores, sports and other event venues, concession stands, etc. In these types of places, conventional visual advertising has some disadvantages. When the landscape is crowded with many visual advertisements, it is difficult for any one of them to stand out above the rest and be noticed.

The advent of low-cost video displays has contributed to greater use of video advertisements, which can draw more attention than static signs. However, in some public locations, such as a grocery store, visitors are often preoccupied with a task, e.g. shopping, and may not look in the desired direction so that their attention falls upon the video display. For this reason, advertisers have combined audio with their video advertising to attract more attention. Advertisers can get the attention of a shopper or visitor to a particular place without the need to have them look in a particular direction. The customer or visitor hears music or a soundtrack, and is naturally drawn to its source.

Audio-visual systems are also frequently used to entertain or inform visitors waiting in predictably long queues. For example, in recent years, amusement park operators have installed audio-visual systems for the entertainment of patrons waiting in line for attractions. These systems can be used both to entertain and to advertise other attractions or products associated with the amusement park. Airports also routinely provide television monitors broadcasting news and other information for travelers. The advent of lower-cost flat-panel video displays has helped make these sorts of systems more common. They can be used to both inform and entertain, making the task of waiting less disagreeable.

Audio-visual systems allow the use of a wider range of advertising or entertainment media in public places. However, they also present a noise problem. In bustling public places, there can be a lot of background noise. In order for advertising or entertainment to be heard, it usually must be turned up louder than the background noise. Unfortunately, this sound carries and reflects to other areas, and simply contributes to the overall background noise, with the result that the location simply becomes louder and louder. This increased background noise can be disagreeable to customers as well as employees, distracting them from their intended tasks. In a retail store environment, rather than increasing sales and customer visits, this additional noise and commotion can have the opposite effect, driving customers away, and distracting them from their shopping. In an airport or amusement park, the increasing din can have the effect of agitating and distressing visitors, rather than making their wait more pleasant.

Moreover, the proximity of typical AV display systems, or purely audio advertising systems, is restricted where they are broadcasting different content. If displays with different content are placed too closely together, the conflicting audio broadcasts will hinder intelligibility, making all of them difficult to understand.

### SUMMARY OF THE INVENTION

It has been recognized that it would be advantageous to develop a system for providing audio-visual content to customers or visitors to a public place that minimizes distractions and minimizes contributions to overall background noise.

The invention advantageously provides a system for providing audio information to persons in an approach path. The system includes an interaction point, and an approach path, leading to the interaction point. A parametric sound system is provided, which includes a parametric speaker disposed adjacent to the interaction point. The parametric sound system is configured for limited delivery of sound in a spatially limited audio zone along the approach path, within a decibel level above ambient noise levels in the area of the interaction point, and sufficiently high to be heard primarily by a person progressing along the approach path.

In a more detailed embodiment thereof, the invention provides a method for providing audio-visual input to customers at a point of purchase at a cashier station. The method includes the steps of providing an approach path for customers to move toward the cashier station, and positioning a display screen and parametric sound system at the cashier station. The display screen has a viewing orientation projected along the approach path, and the parametric sound system includes a parametric speaker coupled to the display screen for processing audio sound corresponding to video data displayed on the display screen. The parametric speaker is directionally oriented, and configured for limited projection of sound along the approach path, within a decibel level above ambient noise and sufficiently high to be heard by a customer, but configured to reduce the propagation of sound outside the approach path.

In accordance with a more detailed aspect of the present invention, the method includes the additional steps of positioning the display screen between a cashier at the cashier station and the customer, and preventing propagation of sound toward the cashier.

In accordance with another more detailed aspect thereof, the invention advantageously provides a method for protecting persons in a localized area from undesired sound. The method includes the steps of orienting a parametric speaker to selectively produce sound along an axis so as to create an audio zone and a null zone, and manipulating the null zone to cover a localized area, and to protect persons in the localized area from sound from the parametric speaker.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is an elevation view of an approach path to a cashier station, incorporating one embodiment of an audio-visual display system in accordance with the present invention.

FIG. 2 is a top view of the approach path of FIG. 1.

FIG. 3 is a perspective view of a plurality of cashier stations incorporating audio-visual display systems in accordance with the present invention.

FIG. 4 is a front view of a product advertising display incorporating an audio broadcast system in accordance with the present invention.

FIG. 5 is a top view of a cashier station and approach path wherein the audio-visual display system is disposed substantially above the cashier.

FIG. 6 is a top view of a parametric emitter showing the audio zone and the null zone.

FIG. 7 is a top view of a curved parametric emitter configured for maintaining a substantially constant sound level along an audio path.

FIG. 8 is a graph of sound dissipation with distance compared to the angular spread of the audio beam for the emitter configuration of FIG. 7.

FIG. 9 is a top view of an array of parametric emitters configured for producing results similar to that of the emitter of FIG. 7.

FIG. 10 is a top view of an alternative parametric emitter configuration for maintaining a substantially constant sound level along an audio path.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the invention as illustrated herein, which would occur to one skilled in the relevant art and having possession of this disclosure, are to be considered within the scope of the invention.

In one embodiment, the present invention provides a system and method for providing audio-visual input to customers at a point of purchase at a cashier station. Advantageously, the system and method provide audio in a manner that is designed to be less distracting to other persons in the area. There are many public places where customers, visitors, etc. are sometimes required to spend time waiting. This may be in a line at a cashier station in a store, at an airport gate, in line at an amusement park, etc. Because waiting can be inherently stressful, it is generally in the interest of the proprietors of these public places to make waiting as pleasant and unstressful as possible.

One way to make waiting more pleasant is to provide information or entertainment in an audio or audio-visual format. Airports routinely provide television monitors to help entertain and inform waiting passengers. Amusement parks provide similar systems to entertain visitors waiting in line for popular rides. However, these types of public places tend to have some basic level of background noise, to which an audio or audio-visual entertainment system would be an additional contributing element. For example, the inventor has found that typical grocery stores have background noise in the range of about 65-69 dB. In order to be heard above the background noise, the output volume of a conventional sound system must be increased to some level substantially above the background noise. Consequently, a conventional audio-visual system would only add to the background noise in a given location, potentially distracting people from their shopping or other tasks. Moreover, multiple AV systems in close proximity to each other but with different content would create confusion.

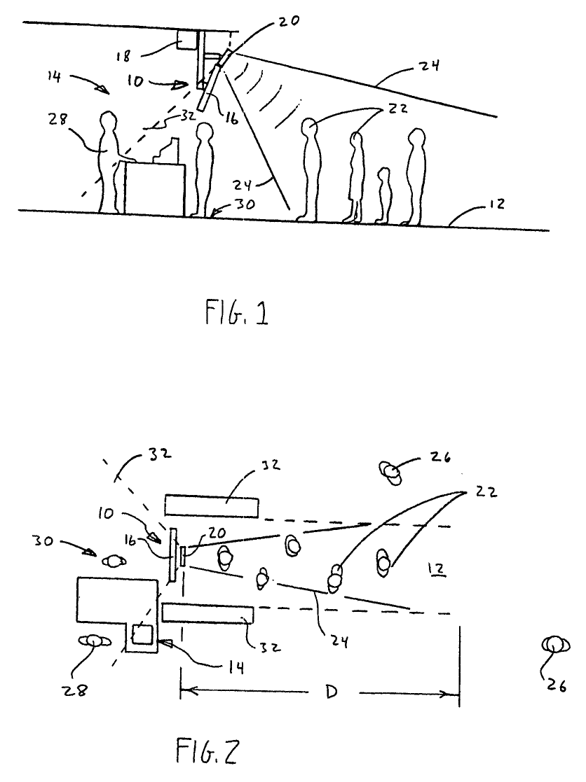

With reference to FIGS. 1 and 2, there are shown side and top views of an audio-visual display system 10 according to the present invention disposed adjacent to an approach path 12 to an interaction point, in this case a cashier station 14. The system generally comprises a visual display screen 16, and a parametric sound system 18 including a parametric emitter or speaker 20 disposed adjacent to the screen. The display screen may be any type of video display (e.g. CRT, LCD, Plasma screen, etc.) and has a viewing orientation along the approach path 12. The parametric sound system and parametric speaker are coupled to the display screen 16 for processing and broadcasting audio sound corresponding to video data displayed on the screen.

The parametric speaker 20 is directionally oriented, and configured for limited projection of sound along the approach path 12, within a decibel level above ambient noise and sufficiently high to be heard by customers 22 in the approach path, but minimizes sound heard in other directions outside the approach path, and creates a null zone behind the speaker, as described below. Parametric speakers are relatively new, but are disclosed in several prior patents, including U.S. Pat. No. 6,011,855 to Selfridge et al. Parametric speakers are configured to broadcast an ultra-sonic sound wave—that is, sound at a frequency that is above the threshold of human hearing—as a carrier wave for a sonic (i.e. audible) sound signal. As the ultra-sonic wave encounters air molecules, the audible sound signal is decoupled from the ultra-sonic carrier wave, producing the desired sound signal in the audible range. Because the audible sound is progressively decoupled from the carrier wave through interaction of the ultra-sonic wave with air molecules, the sound grows in intensity along a column extending from the emitter and directed along the approach path.

The use of an ultra-sonic carrier wave and the decoupling action causes the broadcast signal to be substantially inaudible except in a limited primary audio zone 24. For example, in one embodiment, the sound drops off substantially (to well below the level of background noise) beyond about 10° outside the audio zone. The audible sound also fades out at a certain distance D from the emitter 20. This distance depends upon both the power of the sound broadcast and the frequency of the sound signal. It is well known and understood that sound naturally dissipates with distance from a sound source. However, the higher the frequency, the more rapid will be the dissipation. Thus, ultra-sonic sound waves, having a higher frequency, will dissipate much faster than audible sound, having a lower frequency. Naturally, as the ultrasonic carrier wave dissipates, at some point there will be insufficient energy left to decouple an audible signal from the carrier wave. While this distance can vary as desired, in one embodiment, a distance D of 12 feet has been used. The result is that persons 26 to the left or right of or beyond the audio zone will hear little or no sound from the speaker. However, those within the audio zone will hear clear, strong audio.

A directional video display can also be used and oriented to provide its information in the audio zone or. For example, LCD displays frequently employ a Fresnel lens, which provides a limited angular viewing region. Consequently, under the present invention a video display 16 having a limited viewing angle can be combined with the parametric sound system 18 to limit both audio and video to a limited region. It will be apparent that the audio and video will not necessarily dissipate at the same boundaries or at the same rates. However, according to the present invention a system can be provided wherein a person outside the approach path who would otherwise perceive audio and video content from conventional speakers and video displays can neither hear the audio nor see the video that persons in the approach path receive.

While the embodiment of the invention depicted in FIGS. 1 and 2 comprises a cashier station, the invention is not limited to this application. The present invention is adaptable to an approach path to almost any sort of interaction point. The term “interaction point” is intended to encompass a wide variety of locations for personal interaction, such as a point of inquiry (e.g. an information window or booth where one seeks information), a point of decision or point of selection (e.g. a product display where one decides upon or selects a product), a point of transaction (e.g. a window at a bank, government office, etc.), and a point of sale or point of purchase (e.g. a cashier station). These interaction points can be a personnel location—that is, have an employee, agent, or other person there to attend to the person traversing the approach path—or can be automated, such that the person that traverses the approach path interacts with an automated system rather than another person. Such automated systems can include, for example, an automatic teller machine, a self-service check-in kiosk at an airport, a self-service checkout counter at a grocery store, etc.

Ultra-sonic sound also provides other advantages. First, it tends to inherently cut through noise. Presently, parametric speakers tend to have reduced response in the bass range. However, the human ear has a lower hearing threshold for sound in the bass range than for higher frequency sounds. Consequently, in environments with relatively high background noise, lower frequency audio sounds tend to be masked by the noise. Thus, the reduced bass response of parametric speakers is less noticeable in noisy areas. Additionally, many audio recordings tend to have sound concentrated in the higher frequency ranges, which naturally stands-out over background noise when reproduced through a parametric speaker.

Because of these and other advantages, the system 10 of the present invention can provide clear audio in a limited spatial region, and the sound level of that audio can be only slightly higher than the background noise, yet still be clearly audible. As noted above, in a grocery store the background noise may be at a level of 65-69 dB. The inventor has found that in such an environment, the system of the present invention provides clear and intelligible sound at a level of from the high seventies to around 80 dB. More specifically, the system may provide adequately intelligible audio sound when broadcasting from about 75-85 dB.

Additionally, the invention can also be used in areas where background noise is not as significant, but where sonic isolation of certain areas or activities is desirable. For example, a library, business office, or government office could provide a parametric broadcast system in an isolated are to provide information to patrons in such a way as to prevent disturbance to other patrons. Such a system could be provided at a government office or other similar place where several queues of patrons line up adjacent to a plurality of windows or service positions. Where lines are long and each window or service position relates to a different service, it can be difficult for persons approaching the ends of the lines to choose the correct one, and a general repeated explanatory audio broadcast to all patrons can be annoying, both to those in line and to other patrons having other business. Consequently, a unique, targeted broadcast using a parametric system as describe herein could be provided to each queue. Additionally, sensors to detect new arrivals could direct an initial broadcast solely to each new arrival, directing them to the appropriate approach path, without bothering other patrons. Other such embodiments are also possible.

For the present invention, the primary audio zone 24 is designed to coincide with the space in the approach path 12, so that customers 22 in the approach path hear the sound clearly, but other customers do riot. This removes a distraction for the other customers, and reduces the potential contribution to background noise. In the embodiment of FIGS. 1 and 2, the audio-visual system is disposed above the approach path 12. However, other placements are also possible. For example, as shown in FIG. 5, the display screen 16 and speaker 20 may be placed substantially over the cashier position 14, to one side of the approach path. This placement can allow the screen and speaker to be placed at a lower elevation—more at eye level—which allows the audio beam to be more highly focused in the vertical dimension, while still providing a sufficiently wide audio zone to encompass the customers in the approach path.

At the same time, this off-axis placement to one side of the approach path can produce a low sound region outside the primary audio zone 24 in the approach path 12 near the cashier station 14. Several arrangements are possible to provide audio in this region. One solution, shown in FIG. 5, is to provide an additional side speaker 21 with a slightly angled orientation to direct sound to a secondary audio zone 25 for full coverage. Other arrangements are also possible to address the low sound region. For example, one alternative is to simply widen the audio beam and orient the speaker such that adequate sound is provided in the low sound region. However, this can spread the audio into undesired regions outside the approach path. Another solution is to provide a parametric speaker with a convexly curved front surface, which widens the primary audio zone. Alternatively, as shown in FIG. 5, a series of flat parametric speakers can be arranged in an arcuate configuration to provide the needed coverage. As yet another alternative, beam-steering techniques can be used is disclosed in copending U.S. patent application Ser. No. 09/787,972 (based on international application no. PCT/US99/19580), U.S. patent application Ser. No. 09/430,801, and U.S. patent application Ser. No. 09/850,523. Using these techniques, a single parametric speaker can direct differing quantities of sound in different directions, as desired, without the need for any mechanical or physical reorientation of the speaker. This allows a single speaker to produce an asymmetrical audio zone, similar to that shown in FIG. 5, without the need for two speakers.

As a general matter, the display screen 16 and audio speaker 20 are positioned relative to the cashier 28 at the cashier station 14 and the customers 22 in the approach path, so that the audio zone 24 encompasses the customers in the approach path, but not the cashier. Additionally, as shown in FIGS. 1, 2 and 5, it can be desirable to have a customer position 30 at the cashier station that is also outside the audio zone. This helps remove distractions and annoyance for both the cashier and a customer that is dealing with the cashier.

Advantageously, the parametric speakers 20 also provide a null zone 32, shown in FIG. 6. As noted above, the highly directional nature of the sound from the parametric speaker reduces the propagation of sound outside the approach path 12. Outside the primary audio zone 24, the quantity of audible sound rapidly drops off until reaching the null zone. The null zone is a region of space behind the parametric speaker in which sound from the emitter is substantially reduced, such that it is substantially inaudible, particularly when compared to ambient background noise. Additionally, the center 34 of the null zone 32 represents a location where there is substantially no sound from the parametric speaker at all, regardless of background noise. Consequently, a person within the audio zone 24 hears the full audio sound, while one outside the audio zone hears far less (if at all), and a person in the null zone hears substantially none, particularly if at the center of the null zone.

The existence of the null zone 32 allows the system 10 to be manipulated so as to place the audio zone 24 where desired, or to place the null zone where desired, or both. Just as the angular spread of the audio zone can be adjusted to give the desired coverage, so too the size and spread of the null zone can be adjusted for the purpose of encompassing locations that are intended to be quiet. For example, the null zone can be configured to encompass the cashier 28 and the immediate region of the cashier station 14, as shown in FIGS. 1 and 5. However, the null zone can also be widened to encompass the cashier station and the customer position 30, as shown in FIG. 2.

The audio-visual information broadcast by the system 10 can be any type of information. It can be entertainment, such as a movie or television broadcast, to help customers pass the time waiting. It can be news and other information. It can be advertising of any kind, such as for products available on a display 36 adjacent to the cashier station 14. The system can be part of a network placed at several different locations. For example, a large retailer with many stores in many scattered locations could install this system at checkout counters in all of their stores, and simultaneously broadcast one or several channels of content, such as via satellite, to these systems at all of their stores to create an information network. Many other such configurations are also possible.

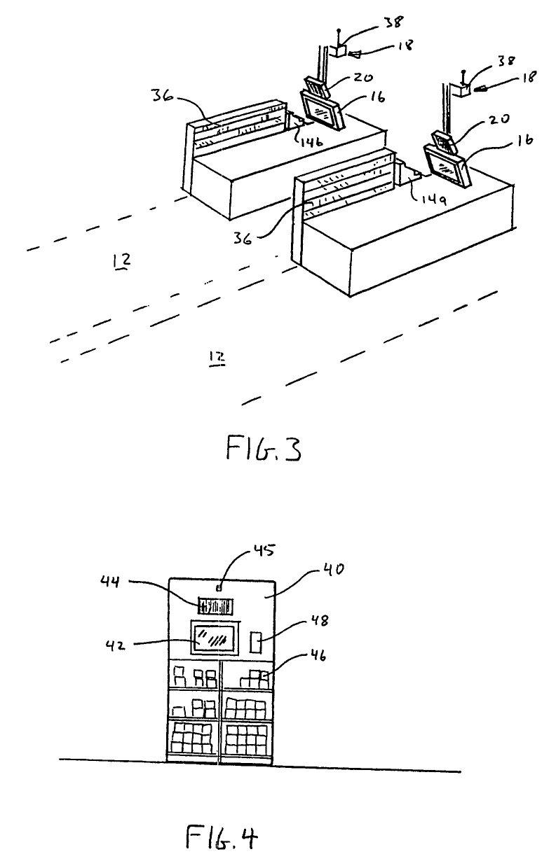

Advantageously, the system of the present invention is compatible with multiple audio broadcast systems in relatively close proximity. For example, viewing FIG. 3, a plurality of cashier stations 14a, 14b, incorporating audio-visual display systems 10 in accordance with the present invention could be located in relatively close proximity to each other, yet provide different audio-visual information without significant interference and confusion. In the embodiment shown, each cashier station includes a wireless receiver 38, which is interconnected with the parametric sound system 18. The receiver receives a broadcast signal (essentially a television signal) on a selected frequency. The parametric sound system combines the audio portion of the signal with an ultra-sonic carrier wave, and transmits this combined signal to the parametric speaker 20, which broadcasts the sound into the air. Because of the focused, directional nature of the broadcast sound, one cashier station 14a could broadcast advertising or information, while the adjacent cashier station 14b could simultaneously display a movie for entertainment of customers. Because the sound is substantially limited to the unique approach path to each cashier station, customers in adjacent lines, other customers shopping, and even the cashier, will not hear it, or will hear it at a greatly diminished level that is easier to ignore.

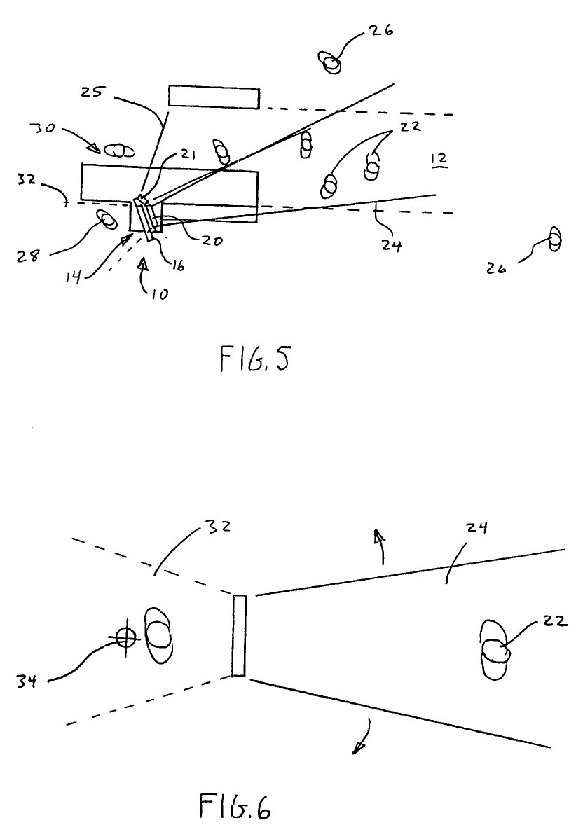

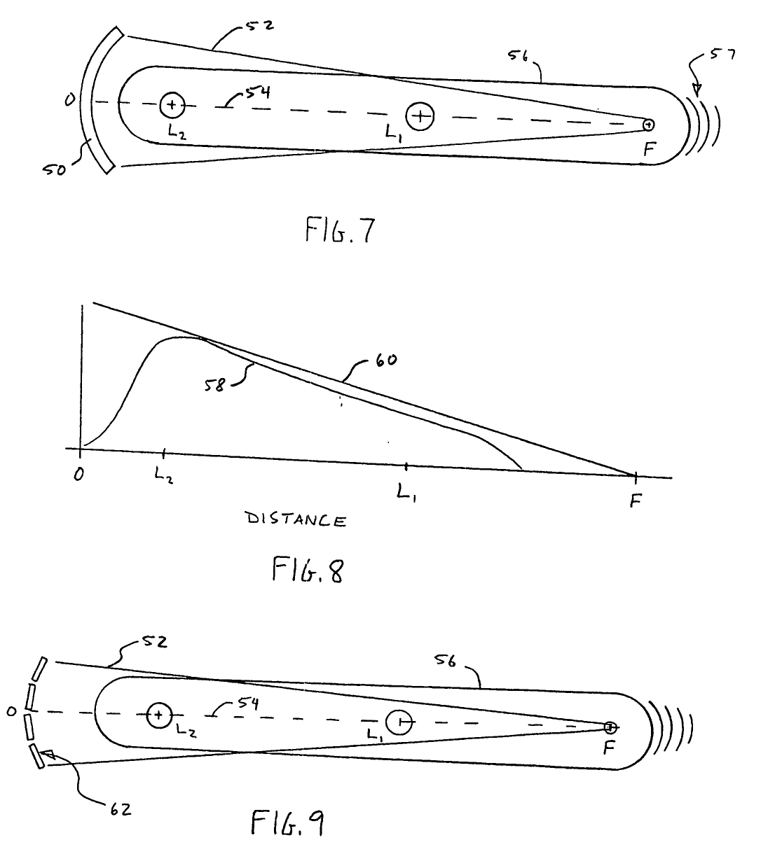

It will be apparent that this sort of audio system could also be used in other ways. For example, as shown in FIG. 4, the interaction point can be a point of selection, such as a product advertising display 40 configured in accordance with the present invention. The display can include a display screen 42 and a parametric speaker 44 configured to display video and broadcast sound only in the immediate vicinity of the display, such as along an approach path to the display. Product 46 being advertised by the display can be located immediately adjacent to the display. The advertising display could be informational as well as mere advertising. For example, in a home improvement store, this type of display could be located adjacent to a new product, and the display could provide instruction on how the product is installed, used, maintained, etc. In this case, the audio zone defines an approach path which leads a customer to the display. In essence, the customer notices the directional sound and is lead toward the source, along the approach path.

The display in FIG. 4 could also be interactive, such as by providing an input device, such as a keypad 48, allowing customers to choose which information or video they would like to view, or to provide input requested by the display broadcast. Many other variations are also possible. Advantageously, because of the highly directional, localized parametric sound system, uninterested shoppers arc not distracted, and the level of background noise is maintained as low as possible, making shopping as stress-free as possible.

The advertising display 40 could also be provided with a detection device 45 for detecting the approach or presence of a person. The detection device could be one of many types of sensors or detectors that are well known and commercially available, such as a motion sensor, an infrared sensor, etc. The display can include a control system that is configured to actuate the audio and/or video broadcast only when a person is detected in or near the approach path. This sort of configuration further serves to provide the audio and/or video information in a way that minimizes annoyance and distraction of persons outside the approach path.

In this way, the invention can be viewed as a system for capturing the awareness of persons and diverting or redirecting their attention along an approach path. It is essentially a system for changing movement using sound. When used this way, the system could comprise sound only, with no video. In any event, the system essentially uses audio as a primary influence for redirecting the attention of persons, or initiates a broadcast upon detection of the presence of a person. The audio zone defines an approach path which leads a customer to a desired location. In essence, the customer notices the directional sound, or is detected by the system, and is then lead by the sound toward the source, along the approach path. There are many ways this sort of system could be used. For example, it could provide a virtual guide through a building or other unfamiliar place, giving a highly directionally-oriented audio cue directing people to traverse a desired path through the location.

It will also be apparent that aspects of the system depicted in FIG. 4 can be combined with other embodiments described herein. For example, self-service transaction locations—e.g. self-service checkout stations in retail stores, self-service check-in kiosks at airports—are now provided in many places. These sorts of transaction locations can include a parametric broadcast system for providing information and feedback to persons in an approach path to the location, and also to provide continuing information to a person actually at the location and involved in a transaction. Advantageously, the system can be configured so that the person at the transaction location receives different information than other persons in the approach path. Specifically, the system can include a plurality of parametric speakers, configured such that persons in the approach path receive, for example, information helpful for preparing them to undertake a transaction, while the person at the transaction location can receive feedback related to his or her specific transaction, out of hearing of those persons still in the approach path. This can be desirable for privacy and other reasons.

Another aspect of the invention is the capability to maintain a substantially constant sound level along an audio path. Viewing FIG. 7, a single curved parametric emitter 50 can be configured (i.e. focused) to project a sound beam 52 toward a focal point F. The emitter is configured to place the focal point beyond a first listener position L₁, such that the sound beam will gradually narrow along the audio path 54. The rate of narrowing of the beam can be correlated with the rate of dissipation of sound with distance from the origin O, such that the sound is concentrated at approximately the same rate that its intensity falls off with distance. The result will be an audible sound level that is maintained roughly constant in a primary audio zone 56 along the audio path 54 between the first listener position L₁ and a second listener position L₂ that is nearer the emitter 50. Beyond the focal point F, the primary audio zone ends as the audio volume gradually drops off, as indicated at 57.

As shown in the graph of FIG. 8, the rate of dissipation of sound with distance from the emitter, represented by the curved line 58, is not a linear function. However, the change in angular spread or focusing of the beam with distance from the source, represented by straight line 60, is roughly linear because it is defined by the geometry of the emitter and the straight line distance to the focal point along the approach path. Nevertheless, as shown in FIG. 8, the configuration of the emitter and the parameters of the sound signal can be manipulated so as to generally align these two graphs within a certain region, such that these parameters generally correspond along the approach path between a near listener position L₂ and a distant listener position L₁. Thus, the level of audible sound can be maintained roughly constant along the audio path because the quantity of audio energy per unit of space is maintained roughly constant. Viewed differently, the ultrasonic primary wave can be maintained roughly constant along the audio path because it is being spatially focused at simultaneously the same rate that it is dissipating.

Thus, passersby will not hear the audio until they arrive near or substantially at the first listener position L₁, but will continue to hear the audio at a substantially constant level as they progress along the approach path to the second listener position L₂ near the emitter. Once they move beyond the second listener position, the sound level will drop off, as indicated by the curve, and the listener will pass into a quiet zone.

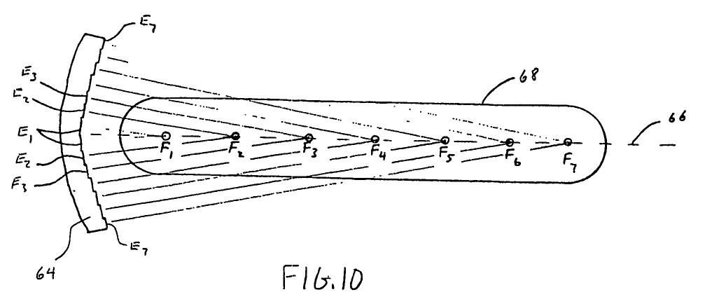

As an alternative to the single emitter of FIG. 7, the same effect can be produced by an array 62 of planar emitters 63 arranged in a curved configuration, shown in FIG. 9. This array of emitters approximates the geometry of the single curved emitter 50 of FIG. 7, and is aimed at a focus point F beyond the first listener position L₁ to produce the same effect. It will be apparent that the curved emitter of FIG. 7 may be circularly or non-circularly curved (e.g. elliptical, parabolic, etc.), and the curvature may be in more than one dimension (e.g. hemispherical, paraboloid, etc.). Likewise, the array of emitters in FIG. 9 can be arranged in a circularly or non-circularly curved configuration, whether singly or multiply curved.

As an alternative, viewing FIG. 10, an ultra-sonic emitter 64 (or an array of emitter pairs) can be configured with a plurality of pairs of emitter segments E₁, E₂, . . . E₇ that are each focused toward a corresponding plurality of focal points F₁, F₂ . . . F₇ disposed along a linear approach path 66. Each pair of emitter segments Eₙ (or pair of emitters) is aimed so as to project sound to its distinct focal point Fₙ (or point of convergence) some distance from the emitter or array along the approach path. Because of the convergence of two beams at each focal point, each part of the emitter pair produces about half the total sound desired at each respective convergence point. Thus, if a pair of emitters E1 and E2 each produce about 20 db, this will result in about 40 db at the corresponding focus point. Because of the geometry of the emitter 64 (or the array of emitters), the series of focal points fall along a line, causing the system to maintain a substantially constant sound level within an audio zone 68 along the line.

The intensity of sound emitted from each pair of emitters Eₙ can be adjusted specifically for the distance of the respective focal point Fₙ from the emitter, so that the sound from each pair of emitters falls off rapidly beyond the respective focal points, thus providing a narrow primary audio zone 68 that is highly focused and elongate. With the plurality of focal points, this configuration provides substantially constant audio sound along the approach path from the vicinity of the first focal point F1 to the vicinity of the last focal point F7, but the sound drops off rapidly when one moves away from the approach path.

Advantageously, the embodiment of FIG. 10 can be configured for both straight and curved lines. Each coordinated pair of emitters or emitter segments can be arranged to place their respective focal point at any desired location. Thus, by manipulating the geometry of the emitter or emitter array, a series of focal points can be arranged along a line that is curved in almost any way imaginable.

Moreover, where a plurality of emitter pairs are used, the emitter pairs can be moveable, so that the exact location of each focal point can be individually adjusted. This allows the approach path to be adjustable over time. For example, where customer lines meander over time, a system for detecting the position of the line at a given time (e.g. using motion sensors, etc.) can be coupled to the emitter array, and can reorient the emitter pairs to adjust the audio zone to accommodate the position of the line at that given moment. This could be helpful, for example, at ticket offices, where the line of customers waiting to buy popular tickets can get very long, and persons at the back of the line may not be able to see whether they are even in the correct line.

Similarly, a single adjustable system could be used to sequentially cover a plurality of defined customer lines. Such a system could mechanically adjust to focus the emitter pairs along a first line and broadcast some message or information, then readjust to broadcast the same or a different message to a second line of customers. This can be helpful at, for example, government offices or banks where customers must wait in one of several long lines, and where different information needs to be given to the customers in each line. Instead of bothering all customers with all information, information can be given out on an as-needed basis with a single broadcast system. Additionally, where the position of a line is defined, such as at an airport security station or amusement park ride line, but the line meanders in a serpentine or other defined fashion, a single system can be configured to sequentially reorient and focus on different parts of the line to broadcast desired information without disturbing or repeating information to others outside the audio zone.

By way of example, and without limitation, the invention can be described as a method for processing customers at a point of purchase at a cashier station. The method includes the steps of (a) providing an approach path for customers to move toward the cashier station; (b) positioning a display screen at the cashier station with a viewing orientation projected along the approach path; (c) coupling a parametric sound system including a parametric speaker to the display screen for processing audio sound corresponding to video data displayed on the display screen; (d) configuring the parametric speaker for limited delivery of sound projection along the approach path and within a decibel level above ambient noise levels in the area of the cashier station and sufficiently high to be heard by a customer progressing along the approach path; and (e) orienting the parametric speaker with propagation of directional parametric sound output along the approach path.

More particularly, the invention can include the additional steps of: (f) positioning the display screen between a cashier at the cashier station and the customer; and (g) preventing propagation of sound toward the cashier.

As another example, the invention can be described as a system for providing audio information to persons in an approach path, comprising a cashier station, an approach path leading to the cashier station, and a parametric sound system including a parametric speaker disposed adjacent to the cashier station, the sound system being configured for limited delivery of sound in a spatially limited audio zone along the approach path and within a decibel level above ambient noise levels in the area of the cashier station, yet sufficiently high to be heard by a customer progressing along the approach path.

More particularly, the invention can include a visual display coupled to the parametric sound system, the system being configured to broadcast audio information corresponding to the output of the visual display.

As another example, the invention can be described as a system or method for protecting persons in a localized area from undesired sound. Such a method comprises the steps of orienting a parametric speaker to produce an audio zone and a null zone, and manipulating the size and/or position of the null zone to cover a localized area and protect persons in a that area from undesired sound. Alternatively, the invention can be described as a method for defining a quiet zone in an audio environment.

As yet another example, the invention can be described as a method for maintaining a substantially constant sound level along an audio path, comprising the steps of focusing sufficient ultra-sonic energy along a path so that the amount of parametric activity approximately equals the rate of dissipation of sound along the path as distance from the emitter increases.

As still another example, the invention can be described as a method for maintaining a substantially constant sound level along an audio path, comprising the steps of correlating an amount of convergence of ultrasonic energy along the audio path with a rate of dissipation of ultrasonic energy along the audio path, so as to define a plurality of sound focal points along the audio path.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. A system for providing audio information to persons in an approach path, comprising:
a. an interaction point;
b. an approach path, leading to the interaction point; and
c. a parametric sound system, including a parametric speaker disposed adjacent to the interaction point, the parametric sound system being configured for limited delivery of sound in a spatially limited audio zone along the approach path and within a decibel level above ambient noise levels in the area of the interaction point, and sufficiently high to be heard primarily by a person progressing along the approach path.

2. A system in accordance with claim 1, wherein the interaction point is selected from the group consisting of a point of decision, a point of selection, a point of transaction, a point of inquiry, and a point of purchase.

3. A system in accordance with claim 1, wherein the decibel level of the audible sound is above about 75 dB.

4. A system in accordance with claim 1, further comprising a detection device, configured to detect the presence of a person entering the approach path.

5. A system in accordance with claim 1, further comprising a controller, for controlling the parametric sound system, and an input device, configured to allow input from a person to the control system.

6. A system in accordance with claim 1, further comprising a controller, for controlling the parametric sound system, configured to receive an audio signal and combine the audio signal with an ultra-sonic carrier wave, and to cause the parametric speaker to broadcast the combined audio signal and carrier wave.

7. A system in accordance with claim 1, further comprising further comprising a visual display, coupled to the parametric sound system, viewable by a person within the approach path, the system being configured to broadcast audio information corresponding to the output of the visual display.

8. A system in accordance with claim 7, wherein the interaction point comprises a cashier station, the approach path comprises a customer waiting line adjacent to the cashier station, and the parametric sound system and video display are disposed between the customer waiting line and the cashier station, such that a person at the cashier station is substantially outside the audio zone.

9. A system in accordance with claim 8, further comprising a null zone, encompassing the cashier station, such that sound from the parametric sound system is substantially inaudible to the person at the cashier station.

10. A system in accordance with claim 1, further comprising a null zone, encompassing a region outside the audio zone, wherein sound from the parametric sound system is substantially inaudible.

11. A system in accordance with claim 1, wherein the parametric sound system comprises a plurality of parametric speakers, configured to broadcast sound to a substantially linear audio zone from a position substantially off a linear axis of the audio zone.

12. A system in accordance with claim 1, wherein the parametric sound system is configured to broadcast sound to cover an audio zone of asymmetric configuration.

13. A system in accordance with claim 12, wherein the parametric sound system comprises a plurality of parametric speakers, configured to cover the asymmetric audio zone.

14. A system in accordance with claim 12, wherein the parametric sound system comprises a parametric speaker having a curved emitter surface, configured to broadcast sound to cover the asymmetric audio zone.

15. A system in accordance with claim 12, wherein the parametric sound system comprises a parametric speaker having beam steering components, such that a single speaker can cover the asymmetric audio zone.

16. A system in accordance with claim 1, wherein the parametric sound system is configured to focus ultra-sonic energy substantially along a line in the audio zone, so that a relative amount of parametric activity at any location along the line dissipates at approximately a rate of dissipation of sound as distance from the speaker increases.

17. A system in accordance with claim 1, further comprising interconnection to a network, such that the system broadcasts audio information that is common to a plurality of additional audio information systems that are interconnected to the network in a plurality of locations.

18. A system in accordance with claim 1, further comprising a plurality of audio information systems in close proximity to the system, each audio information system being configured to broadcast audio information within a unique approach path, such that the sound broadcast by each system is substantially limited to the unique approach path associated therewith, and is substantially inaudible to persons in adjacent approach paths.

19. A system in accordance with claim 18, wherein each audio information system includes a controller, for controlling the parametric sound system, configured to receive an audio signal and combine the audio signal with an ultra-sonic carrier wave, and to broadcast the combined audio signal and carrier wave via the parametric speaker.

20. A system for protecting persons from undesired sound, comprising a parametric speaker, configured to produce an audio zone wherein sound from the parametric speaker is audible, and to produce a null zone wherein sound from the parametric speaker is substantially inaudible, the null zone being configured to substantially protect persons in the null zone from sound from the parametric speaker.

21. A system in accordance with claim 20, wherein the parametric speaker is configured to broadcast sound along an axis of propagation that is substantially coincident with an approach path of persons toward a point of transaction.

22. A system in accordance with claim 20, wherein the null zone is configured to substantially cover a personnel location.

23. A system in accordance with claim 22, wherein the personnel location is selected from the group consisting of a point of inquiry, a point of decision, a point of selection, a point of transaction, and a point of purchase.

24. A method for protecting persons in a localized area from undesired sound, comprising the steps of:
a. orienting a parametric speaker to selectively produce sound along an axis so as to create an audio zone and a null zone; and
b. manipulating the null zone to cover a localized area, and to protect persons in the localized area from sound from the parametric speaker.

25. A method in accordance with claim 24, further comprising the step of placing a person in the localized area.

26. A method in accordance with claim 24, wherein the localized area is selected from the group consisting of a point of inquiry, a point of decision, a point of selection, a point of transaction, and a point of purchase.

27. A method for maintaining a substantially constant sound level along an audio path, comprising the step of broadcasting sufficient ultra-sonic energy along a path using a parametric speaker so that a relative level of parametric activity along the path dissipates approximately at a rate of dissipation of sound as distance from the speaker increases.

28. A method in accordance with claim 27, further comprising the step of correlating an amount of convergence of ultra-sonic energy along the audio path with a rate of dissipation of ultrasonic energy along the audio path, so as to define a plurality of sound focal points along the audio path.

29. A method for processing customers at a point of purchase, comprising the steps of:
a. providing an approach path for customers to move toward a cashier station;
b. positioning a display screen at the cashier station with a viewing orientation projected along the approach path;
c. coupling a parametric sound system including a parametric speaker to the display screen, for processing audio sound corresponding to video data displayed on the display screen; and
d. configuring the parametric speaker for limited delivery of sound projection along the approach path and within a decibel level above ambient noise levels in the area of the cashier station and sufficiently high to be heard by a customer progressing along the approach path.

30. A method as defined in claim 29, further comprising the steps of:
a. positioning the display screen between a cashier at the cashier station and the customer; and
b. reducing propagation of sound toward the cashier.
